(19) United States
(12) Patent Application Publication
(10) Pub. No.: US 2015/0142573 A1
(43) Pub. Date: May 21, 2015

(54) Systems and methods for storing pictures on a cloud platform and printing the pictures from different locations

(71) Applicants: Hung-Chan Chien, Taipei (TW); Chang-Hsieh Lee, Taipei (TW); Shih-Hung Lin, Taipei (TW)

(72) Inventors: Hung-Chan Chien, Taipei (TW); Chang-Hsieh Lee, Taipei (TW); Shih-Hung Lin, Taipei (TW)

(21) Appl. No.: 13/998,663

(22) Filed: Nov. 21, 2013

(51) Int. Cl. G06F 21/62; G06Q 30/02

(52) U.S. Cl. CPC G06F 21/6245; G06Q 30/0261
USPC 705/14.58; 726/28

(57) ABSTRACT

The present invention discloses systems and methods for storing pictures on a cloud platform and printing the pictures from different locations. The system may include a first network device to upload a plurality of image files to a private space on a cloud platform, the cloud platform selectively assigning a unique access code to a set of image files or a single image file within the plurality of image files, and a second network device, which is different from the first network device. The second network device may include a transmitter to communicate with the cloud platform electronically so as to access related image files utilizing the unique access code, wherein the set of image files or the single image file within the plurality of image files may have a respective privacy setting. When the privacy setting is set to open, a user may enter the unique access code at the second network device to access the related image file, and when the privacy setting is set to private, the user may not access the related image file by entering the unique access code at the second network device, even when the unique access code entered is correct.

### CROSS-REFERENCE TO RELATED APPLICATIONS

This application is related to and claims priority to U.S. provisional patent application, U.S. Provisional Application No. 61/758,793 filed on Jan. 31, 2013, by the applicants Kun-Huang Jao et al., entitled “The image processing invention of kiosk, human face identify method applied on kiosk, photo taking device, cloud system service on kiosk, peripheral system service applied on kiosk,” and provisional patent application, U.S. Provisional Application No. 61/786,524 filed on Mar. 15, 2013, by the applicants Yue-Ping Lin et al., entitled “Kiosk device with adjustable housing and applications thereof”.

### FIELD OF THE INVENTION

The present invention relates to systems and methods for storing pictures on a cloud platform and printing the pictures from different locations. In particular, the present invention relates to systems and methods for storing pictures on a cloud platform from the first network device and printing the pictures from any related second network device utilizing a unique access code so as to increase accessibility of these pictures.

### BACKGROUND OF THE INVENTION

As the popularity of web applications increases, more and more users start to share resources, such as image files, audio files and text documents on the Internet. In the conventional art, the most common method to share, for example, image files on the Internet is to post the image files on a blog for family members and friends or even the general public to view. Alternatively, an online photo album may be created and a link to the album may be shared for a particular third party to access. However, neither do these conventional methods provide security of these files nor picture download or printing, function for the third party.

To overcome the above issues, what is needed is a system that can protect the security of the resources shared on the Internet and provide the convenience of sharing and even outputting these resources at the same time and the method for the same. In particular, what is needed is a system that can share resources, such as image files, on a cloud platform and allow the third party to access these resources at any related network device, such as a photo kiosk, and the method for the same.

### SUMMARY OF THE INVENTION

In light of the drawbacks of the above prior arts, one object of the present invention is to provide a system for storing pictures on a cloud platform and printing the pictures from different locations. As such, the security of the image files stored on the cloud platform is enhanced while the convenience of accessing these files is increased.

In accordance with one embodiment of the present invention, the system for storing a plurality of image files on a cloud platform and printing said plurality of image files from different locations may include a first network device uploading the plurality of image files to a private space on the cloud platform through the Internet, the cloud platform selectively assigning a unique access code to a set of image files or a single image file within the plurality of image files, and a second network device having a transceiver to communicate with the clout platform electronically so as to access related image files utilizing the unique access code, wherein the set of image files or the single image file within the plurality of image files has a respective privacy setting, and when the privacy setting is set to open, a user can access the related image files by entering the unique access code at the second network device, and when the privacy setting is set to private, the user cannot access the related image files by entering the unique access code at the second network device, even when the unique access code entered is correct.

In accordance with another embodiment of the present invention, a method for storing a plurality of image files on a cloud platform and outputting the plurality of image files from different locations may include defining a private space on the cloud platform through the Internet so as to upload the plurality of image files to the private space, selectively assigning a unique access code to a set of image files or a single image file within the plurality of image files, and accessing related image files utilizing the unique access code, wherein the step of accessing related image files utilizing the unique access code may include setting a respective privacy setting of the set of image files or the single image file within the plurality of image files, and when the privacy setting is set to open, the related image files can be accessed by entering the unique access code at a second network device, and when the privacy is set to private, the related image files cannot be accessed by entering the unique access code at the second network device, even when the unique access code entered is correct.

Certain embodiments of the invention have other aspects in addition to or in place of those mentioned above. The aspects will become apparent to those skilled in the art from reading of the following detailed description when taken with reference to the accompanying drawings.

### BRIEF DESCRIPTION OF DRAWINGS

FIG. 1 illustrates a schematic view of a system for storing a plurality of image files on a cloud platform and printing the plurality of image files from different locations in accordance to one embodiment of the present invention; and

FIG. 2 illustrates a flow chart of a method for storing a plurality of image files on a cloud platform and outputting the plurality of image files from different locations in accordance with another embodiment of the present invention.

### DETAILED DESCRIPTION OF THE INVENTION

The following embodiments are described in sufficient detail to enable those skilled in the art to make and use the invention. It is to be understood that other embodiments would be evident based on the present disclosure, and that changes may be made without departing from the scope of the present invention.

The present invention provides a system for storing a plurality of image files on a cloud platform and printing the plurality of image files from different locations. In particular, the present invention provides a system utilizing the first network device to upload the plurality of image files onto the cloud platform and the second network device to print out the plurality of image files. The present invention not only enhances the security of the plurality of image files stored on the cloud platform but also provides the convenience to access these image files from different places at any time.

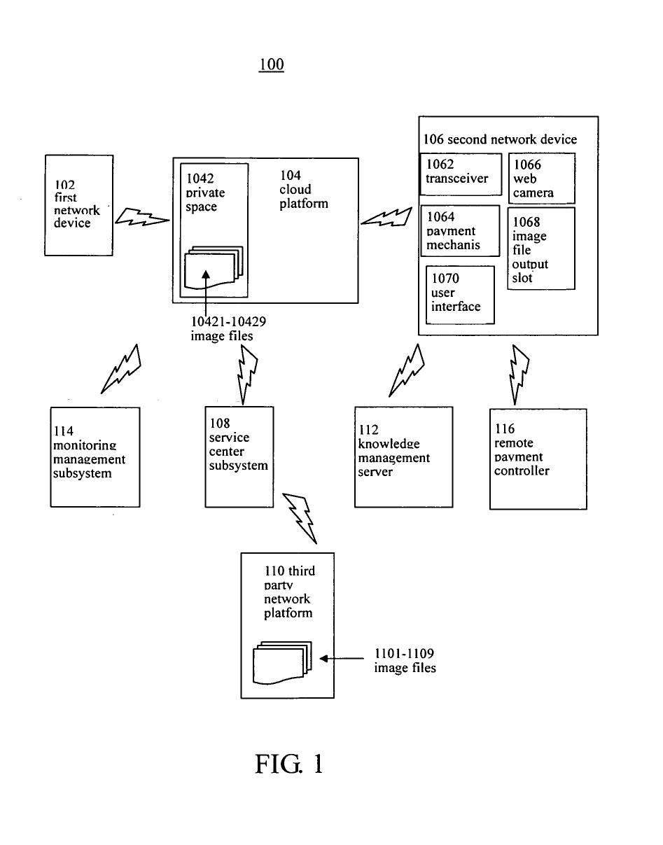

Refer to FIG. 1, which illustrates a schematic view of a system for storing a plurality of image files on a cloud platform and printing the plurality of image files from different locations in accordance with one embodiment of the present invention. As shown in FIG. 1, in one embodiment of the present invention, the system 100 may include a first network device 102. In accordance with one embodiment of the present invention, the first network device 102 may be implemented as a desktop, a notebook, a tablet computer, a smart phone or any electronic device with access to the Internet. In accordance with one embodiment of the present invention, the first network device 102 may communicate with the cloud platform 104 through the Internet.

In accordance with one embodiment of the present invention, the cloud platform 104 may be a platform established through cloud computing. The cloud platform 104 of the present invention has an enhanced security feature to allow a user to access the resources stored on the platform from different places at any time through the use of any network device, such as a notebook. In accordance with one embodiment of the present invention, the user may define a private space 1042 on the cloud platform 104 through the Internet from the first network device 102 so as to become an owner of the private space 1042. In accordance with one embodiment of the present invention, when the user establishes a private space 1042 on the cloud platform 104, the user may create a member account and a corresponding authentication code at the same time. As such, the user with the set of member account and authentication code becomes the owner of the private space 1042 and may access the resources stored in the private space 1042 anytime anywhere through the set of member account and authentication code.

In accordance with one embodiment of the present invention, the owner of the private space 1042 may customize the private space 1042 for different applications. For example, the owner of the private space 1042 may create an online photo album, online postcard, online document, blog, or any resources the owner wishes to access immediately from different places in the private space 1042. As an example, the owner of the private space 1042 may create an online photo album in the private space 1042 and upload a plurality of image files, such as image files 10421-10429, to the online photo album, as such the owner of the private space 1042 may access these image files 10421-10429 stored on the cloud platform 104 anytime anywhere through the use of any network device, such as the first network device 102.

As shown in FIG. 1, in accordance with one embodiment of the present invention, the cloud platform 104 may selectively assign a unique access code to a set of image files or one single image file within the plurality of image files 10421-10429 so as to enhance the security of these image files. Take the above example, the cloud platform 104 may assign a unique access code to an online photo album. The online photo album may include 10 image files, such as image files 10421-10429. In other words, the 10 image files may share the same unique access code. Alternatively, the cloud platform 104 may assign a unique access code to each individual image file in the online photo album, such as image files 10421-10429. That is, each of the 10 image files has a respective unique access code to further enhance the security of each individual image file.

In accordance with one embodiment of the present invention, the image files 10421-10429 stored on the cloud platform 104 has a privacy setting. When a user sets the privacy setting of a set of image files to open, the privacy settings of all image files within the set are set to open. On the other hand, if the user sets the privacy setting of the set of image files to private, the privacy settings of all image files within the set are set to private. Take the above example, when the user sets the privacy setting of the entire online photo album to open, the privacy settings of all 10 image files 10421-10429 in the photo album are set to open. On the other hand, when the user sets the privacy setting of the entire online photo album to private, the privacy settings of all 10 image files 10421-10429 are set to private. Alternatively, the user may choose to set the privacy setting of one single image file to open or private. For example, the user may set the privacy setting of one particular image file in the photo album, such as image file 10421, to open or private. According to the present invention, setting the privacy setting of the resources stored on the cloud platform 104 may further enhance the security of these resources.

As shown in FIG. 1, the system 100 may also include a second network device 106. According to the present invention, the second network device 106 is different from the first network device 102. In accordance with one embodiment of the present invention, the second network device 106 may be implemented as a photo kiosk equipped with network communication capabilities. For example, the photo kiosk 106 may include a transceiver 1062 so as to communicate with the cloud platform 104 electronically. The second network device 106 of the present invention may access related image files utilizing the unique access code assigned by the cloud platform 104. For example, when the user enters a unique access code assigned to an online photo album stored in the private space 1042 through a user interface 1070 at the second network device 106, such as a photo kiosk, the user may access all the image files 10421-10429 in the online photo album from the second network device 106, such as a photo kiosk. Alternatively, when the user enters a unique access code assigned to a particular image file stored in the private space 1042 through the user interface 1070 at the second network device 106, such as a photo kiosk, the user may access the particular image file, such as image file 10421, from the second network device 106, such as a photo kiosk. According to the present invention, the user entering the unique access code at the second network device 106, such as a photo kiosk, may not be the owner of the private space 1042. In other words, the owner of the private space 1042 may share the unique access code of some resource on the cloud platform 104, such as a set of image files, to a third party so that the third party may access the resources, such as a set of image files, associated with the unique access code from the second network device 106, such as a photo kiosk.

In accordance with one embodiment of the present invention, the second network device 106 may further check the privacy setting of the image files the user wishes to access with the cloud platform 104. For example, when the user enters a unique access code related to an online photo album at the second network device 106, and the privacy setting of the online photo album is set to open by the owner of the private space 1042, the user may access all image files in the online photo album from the second network device 106, such as a photo kiosk. On the other hand, when the user enters a unique access code related to an online photo album at the second network device 106, and the privacy setting of the online photo album is set to private by the owner of the private space 1042, the user may not access any image files in the online photo album from the second network device 106, such as a photo kiosk, even if the unique access code entered is correct. According to the present invention, the double authentication mechanism allows the owner of the private space 1042 to further control the privacy of related resources after sharing the unique access code with the third party. In other words, even if the third party obtains the unique access code of some image files, only when the owner of the private space 1042 allows the third party to access these files, such as only in a particular time period, can the third party access the files accordingly. Therefore, the owner of the private space 1042 may take control of the privacy of related resources after sharing the unique access code with the third party, such as by setting the privacy setting of the shared resource to private.

In accordance with one embodiment of the present invention, unlike a general user, the owner of the private space 1042 may access the resources, such as any image file, in the private space 1042 anytime anywhere by entering the member account and authentication code at the second network device 106, such as a photo kiosk, so as to enhance the convenience of accessing these resources stored on the cloud platform.

In accordance with another embodiment of the present invention, the second network device 106 may also include a web camera 1066. The web camera 1066 may identify a user's biological feature for authentication purpose. For example, if the user of the second network device 106 is an owner of the private space 1042, then in addition to authenticating the member account and authentication code entered by the user, the second network device 106 may also capture the user's biological feature, such as finger print, eye ball, facial feature, etc., through the web camera 1066, and match such feature with data stored in a database, such as monitoring management subsystem 114, which is described in detail later, so as to enhance the security of the resources stored on the cloud platform.

In accordance with one embodiment of the present invention, as shown in FIG. 1, the second network device 106 may further include a payment mechanism 1064. The payment mechanism 1064 of the present invention may generate a payment code. The payment code of the present invention may be associated with one or more image files selected by the user. When the user of the second network device 106 wishes to output one or more selected image files, the payment mechanism 1064 may check a payment code associated with the one or more selected image files. If the payment code is linked to a “paid” status, then the second network device 106 may output related image files through the image file output slot 1068 shown in FIG. 1. On the other hand, if the payment code is linked to an “unpaid” status, then the second network device 106 may not output related image files through the image file output slot 1068 shown in FIG. 1.

As shown in FIG. 1, in accordance with one embodiment of the present invention, the system 100 may also include a remote payment controller 116 to communicate with the second network device 106. The remote payment controller 116 of the present invention may be installed at, for example, a sales counter of a convenient store or integrated with a point of sales (POS) system of the store. As an example, the user may bring a print slip with the payment code to the store counter to make a payment. After the payment is made, the remote payment controller 116 installed at the counter or integrated with the POS system may send a message to the second network device 106 so as to change the payment status of the payment code to “paid.” Then, the user may go to the second network device 106 to output the selected image files, or the user may enter a confirmation code or utilize other authentication mechanisms to print out selected image files.

In accordance with one embodiment of the present invention, the system 100 may also include a monitoring management subsystem 114 to communicate with the cloud platform 104, as shown in FIG. 1. The monitoring management subsystem 114 of the present invention may be responsible for maintaining security information, such as the member account information, authentication code as well as the unique access code of the owners' of the private space 1042. As mentioned above, the monitoring management subsystem 114 may also store the biological features of the owners' of the private space 1042 so as to further perform identification check to the user who wishes to access the resources stored in the private space on the cloud platform 104.

As shown in FIG. 1, in accordance with one embodiment of the present invention, the system 100 may also include a service center subsystem 108. The service center subsystem 108 may communicate with the cloud platform 104 so that the owner of the private space 1042 may access the resources stored on a third party network platform 110, such as image files 1101-1109, at the second network device 1062 through the member authentication code without logging into the third party network platform 110.

As shown in FIG. 1, in accordance with one embodiment of the present invention, the system 100 may also include a knowledge management server 112. The knowledge management server 112 of the present invention may communicate with the second network device 106. In accordance with one embodiment of the present invention, the knowledge management server 112 may selectively provide promotional activity information to the second network device 106 based on the location of the second network device 106. As such, the second network device 106 may present such promotional activity information on, for example, a touch screen, such as user interface 1070, of the second network device 106 to the user.

In accordance with one embodiment of the present invention, the second network device 106 may send information collected from the user back to the knowledge management server 112 periodically or randomly so that the knowledge management server 112 may determine specific market information. For example, when operating at the second network device 106, the user may be attracted to the promotional activity information shown on the touch screen and click on some detailed information. The second network device 106 may keep count of the number of clicks for a particular promotional activity, such as 150 clicks in a month, and send such information back to the knowledge management server 112 periodically, such as monthly. The knowledge management server 112 may then determine user preference and the popularity of a certain promotional activity in a given location. When the user enters more information with respect to a particular promotional activity at the second network device 106, such as the user may provide his/her personal data to enter a contest, or the user may fill out a survey to obtain sample, etc., the second network device 106 may also send the collected information back to the knowledge management server 112 real time so that the collected information becomes the basis for the knowledge management server 112 to determine the market information.

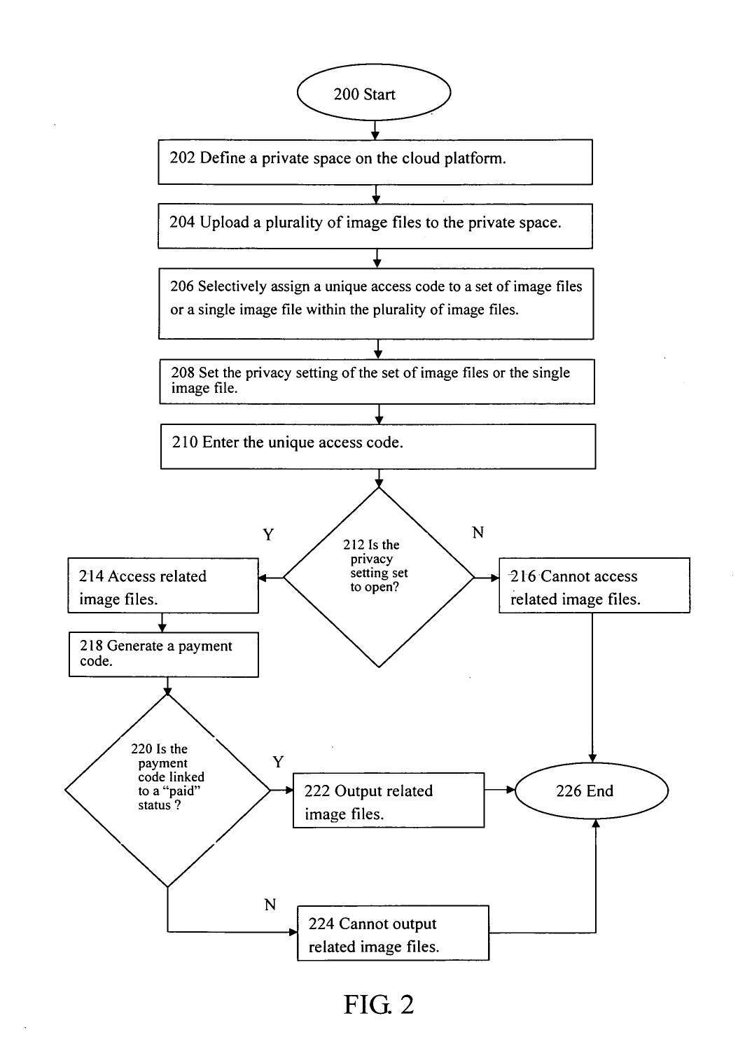

Refer to FIG. 2, which illustrates a flow chart of a method for storing a plurality of image files on a cloud platform and outputting the plurality of image files from different locations in accordance with one embodiment of the present invention. In accordance with one embodiment of the present invention, the present method utilizes the first network device 102 to upload a plurality of image files onto the cloud platform 104 and utilizes the second network device 106 to output the image files. The present method not only provides security to the plurality of image files stored on the cloud platform, but also increases the convenience of accessing these image files anytime anywhere. As shown in FIG. 2, the present method starts at step 200.

In accordance with one embodiment of the present invention, the present method may define a private space 1042 on the cloud platform 104 at step 202. The cloud platform 104 may be a platform established through cloud computing. The cloud platform 104 of the present invention has an enhanced security feature to allow a user to access the resources stored on the platform from different places at any time through the use of any network device, such as a notebook. In accordance with one embodiment of the present invention, the user may define a private space 1042 on the cloud platform 104 through the Internet from the first network device 102 so as to become an owner of the private space 1042. In accordance with one embodiment of the present invention, when the user establishes a private space 1042 on the cloud platform 104, the user may create a member account and a corresponding authentication code at the same time. As such, the user with the set of member account and authentication code becomes the owner of the private space 1042 and may access the resources stored in the private space 1042 anytime anywhere through the set of member account and authentication code.

In accordance with one embodiment of the present invention, the owner of the private space 1042 may customize the private space 1042 for different applications. For example, the owner of the private space 1042 may create an online photo album, online postcard, online document, blog, or any resources the owner wishes to access immediately from different places in the private space 1042. As an example, the owner of the private space 1042 may create an online photo album in the private space 1042 and upload a plurality of image files, such as image files 10421-10429, to the online photo album, as shown in step 204 of FIG. 2. As such, the owner of the private space 1042 may access these image files 10421-10429 stored on the cloud platform 104 anytime anywhere through the use of any network device, such as the first network device 102.

Then, at step 206, the cloud platform 104 may selectively assign a unique access code to a set of image files or a single image file within the plurality of image files 10421-10429 so as to enhance the security of these image files. Take the above example, the cloud platform 104 may assign a unique access code to an online photo album. The online photo album may include 10 image files, such as image files 10421-10429. In other words, the 10 image files may share the same unique access code. Alternatively, the cloud platform 104 may assign a unique access code to each individual image file in the online photo album, such as image files 10421-10429. That is, each of the 10 image files has a respective unique access code to further enhance the security of each individual image file.

In accordance with one embodiment of the present invention, the image files 10421-10429 stored on the cloud platform 104 has a privacy setting. As shown in FIG. 2, the privacy setting of a set of image files, such as image files 10421-10429, or a single image file, such as image file 10421, may be set at step 208. When a user sets the privacy setting of a set of image files to open, the privacy settings of all image files within the set are set to open. On the other hand, if the user sets the privacy setting of the set of image files to private, the privacy settings of all image files within the set are set to private. Take the above example, when the user sets the privacy setting of the entire online photo album to open, the privacy settings of all 10 image files 10421-10429 in the photo album are set to open. On the other hand, when the user sets the privacy setting of the entire online photo album to private, the privacy settings of all 10 image files 10421-10429 are set to private. Alternatively, the user may choose to set the privacy setting of one single image file to open or private. For example, the user may set the privacy setting of one particular image file in the photo album, such as image file 10421, to open or private. According to the present invention, setting the privacy setting of the resources stored on the cloud platform 104 may further enhance the security of these resources.

Then, at step 210, a user may enter a unique access code at the second network device 106, such as a photo kiosk. According to the present invention, the second network device 106 may be different from the first network device 102. In accordance with one embodiment of the present invention, the second network device 106 may be implemented as a photo kiosk equipped with network communication capabilities. For example, the photo kiosk 106 may include a transceiver 1062 so as to communicate with the cloud platform 104 electronically. The second network device 106 of the present invention may access related image files utilizing the unique access code assigned by the cloud platform 104. For example, when the user enters a unique access code assigned to an online photo album stored in the private space 1042 through a user interface 1070 at the second network device 106, such as a photo kiosk, the user may access all the image files 10421-10429 in the online photo album from the second network device 106, such as a photo kiosk. Alternatively, when the user enters a unique access code assigned to a particular image file stored in the private space 1042 through the user interface 1070 at the second network device 106, such as a photo kiosk, the user may access the particular image file, such as image file 10421, from the second network device 106, such as a photo kiosk. According to the present invention, the user entering the unique access code at the second network device 106, such as a photo kiosk, may not be the owner of the private space 1042. In other words, the owner of the private space 1042 may share the unique access code of some resource on the cloud platform 104, such as a set of image files, to a third party so that the third party may access resources, such as a set of image files, associated with the unique access code from the second network device 106, such as a photo kiosk.

In accordance with one embodiment of the present invention, the present method may determine whether the privacy setting related to the unique access code of an image file is set to open or not at step 212 so as to further secure the privacy of the image files the user wishes to access, as shown in FIG. 2. For example, when the user enters a unique access code related to an online photo album at the second network device 106, and the privacy setting of the online photo album is set to open by the owner of the private space 1042, the user may access all image files in the online photo album from the second network device 106, such as a photo kiosk, at step 214. On the other hand, when the user enters a unique access code related to an online photo album at the second network device 106, and the privacy setting of the online photo album is set to private by the owner of the private space 1042, the user may not access any image files in the online photo album from the second network device 106, such as a photo kiosk, even if the unique access code entered is correct. According to the present invention, the double authentication mechanism allows the owner of the private space 1042 to further control the privacy of related resources after sharing the unique access code with the third party. In other words, even if the third party obtains the unique access code of some image files, only when the owner of the private space 1042 allows the third party to access these files, such as only in a particular time period, can the third party access the files accordingly. Therefore, the owner of the private space 1042 may take control of the privacy of related resources after sharing the unique access code with the third party, such as by setting the privacy setting of the shared resource to private.

In accordance with one embodiment of the present invention, the owner of the private space 1042 may access the resources, such as any image file, on the private space 1042 anytime anywhere by entering the member account and authentication code at the second network device 106, such as a photo kiosk, so as to enhance the convenience of accessing these resources stored on the cloud platform (now shown).

In accordance with another embodiment of the present invention, the present method may include a step of identifying a user's biological feature for authentication purpose (not shown). Such identifying step may be implemented by the web camera 1066 installed on the second network device 106. For example, if the user of the second network device 106 is an owner of the private space 1042, then in addition to authenticating the member account and authentication code entered by the user, the second network device 106 may also capture the user's biological feature, such as finger print, eye ball, facial feature, etc., through the web camera 1066, and match such feature with data stored in a database, such as monitoring management subsystem 114, so as to enhance the security of the resources stored on the cloud platform.

In accordance with one embodiment of the present invention, the present method may further include a step of generating a payment code, as shown in step 218 of FIG. 2. The step of generating a payment code may be implemented by the payment mechanism 1064 of the second network device 106. The payment mechanism 1064 of the present invention may generate a payment code. The payment code of the present invention may be associated with one or more image files selected by the user. When the user of the second network device 106 wishes to output one or more selected image files, the payment mechanism 1064 may check a payment code associated with the one or more selected image files. If the payment code is linked to a “paid” status, then the second network device 106 may output related image files through the image file output slot 1068 shown in FIG. 1. On the other hand, if the payment code is linked to an “unpaid” status, then the second network device 106 may not output related image files through the image file output slot 1068 shown in FIG. 1, as shown in step 224 of FIG. 2. The present method ends at step 226.

In accordance with one embodiment of the present invention, the present method may also include a step of receiving a payment message so as to confirm the payment code is linked to a paid status (not shown). Such step may be implemented through the payment mechanism 1064 shown in FIG. 1. For example, the user may bring a print slip with the payment code to a store counter to make a payment. After the payment is made, the remote payment controller 116 installed at the store counter or integrated with the POS system may send a message to the payment mechanism 1064 so as to change the payment status of the payment code to “paid.” Then, the user may go to the second network device 106 to output the selected image files, or the user may enter a confirmation code or utilize other authentication mechanisms to output selected image files.

In accordance with one embodiment of the present invention, the present method may also include a step of maintaining security information, such as the member account information, authentication code as well as the unique access code of the owners' of the private space 1042 (not shown). Such step may be implemented through the monitoring management subsystem 114. As mentioned above, the monitoring management subsystem 114 may also store the biological features of the owners' of the private space 1042 so as to further perform identification check to the user who wishes to access the resources stored in the private space on the cloud platform 104.

In accordance with one embodiment of the present invention, the present method may also include a step of accessing image files stored on a third party network platform through the member authentication code without logging into the third party network platform (not shown). In accordance with one embodiment of the present invention, the step may be implemented by the service center subsystem 108. The service center subsystem 108 may communicate with the cloud platform 104 so that the owner of the private space 1042 may access the resources stored on a third party network platform 110, such as image files 1101-1109 at the second network device 1062 through the member authentication code without logging into the third party network platform 110, as explained above.

In accordance with one embodiment of the present invention, the present method may include a step of selectively providing promotional activity information to the second network device based on the location of the second network device (not shown). Such step may be implemented through the knowledge management server 112. The knowledge management server 112 of the present invention may communicate with the second network device 106. In accordance with one embodiment of the present invention, the knowledge management server 112 may selectively provide promotional activity information to the second network device 106 based on the location of the second network device 106. As such, the second network device 106 may present such promotional activity information on, for example, a touch screen, such as user interface 1070, of the second network device 106 to the user, as explained above.

In accordance with one embodiment of the present invention, the present method may also include a step of sending information collected from the user back to the knowledge management server periodically or randomly to determine specific market information (not shown). In accordance with one embodiment of the present invention, the step may be implemented by the second network device 106 sending information collected from the user back to the knowledge management server 112 periodically or randomly through the transceiver 1062 so that the knowledge management server 112 may determine the market information. For example, when operating at the second network device 106, the user may be attracted to the promotional activity information shown on the touch screen and click on some detailed information. The second network device 106 may keep count of the number of clicks for a particular promotional' activity, such as 150 clicks in a month, and send such information back to the knowledge management server 112 periodically, such as monthly. The knowledge management server 112 may then determine user preference and the popularity of a certain promotional activity in a given location. When the user enters more information with respect to a particular promotional activity at the second network device 106, such as the user may provide his/her personal data to enter a contest, or the user may fill out a survey to obtain sample, etc., the second network device 106 may also send the collected information back to the knowledge management server 112 real time so that the collected information becomes the basis for the knowledge management server 112 to determine the market information.

While the invention has been described in conjunction with exemplary preferred embodiments, it is to be understood that many alternatives, modifications, and variations will be apparent to those skilled in the art in light of the foregoing description. Accordingly, it is intended to embrace all such alternatives, modifications, and variations that fall within the scope of the included claims. The scope of the claims, therefore, should be accorded the broadest interpretation so as to encompass all such modifications and similar arrangements. All matters set forth herein or shown in the accompanying drawings are to be interpreted in an illustrative and non-limiting sense.

What is claimed is:

1. A system for storing a plurality of image files on a cloud platform and printing said plurality of image files from different locations, said system comprising:
a first network device uploading said plurality of image files to a private space on said cloud platform through the Internet;
said cloud platform selectively assigning a unique access code to a set of image files or a single image file within said plurality of image files;
a second network device different from said first network device, said second network device having a transceiver to communicate with said cloud platform electronically so as to access related image files utilizing said unique access code,
wherein said set of image files or said single image file within said plurality of image files has a respective privacy setting, and when said privacy setting is set to open, a user can access said related image files by entering said unique access code at said second network device, and when said privacy setting is set to private, said user cannot access said related image files by entering said unique access code at said second network device, even when said unique access code entered is correct.

2. The system of claim 1, wherein when said user is an owner of said private space, said user can access said related image files by entering said unique code at said second network device or any image file stored in said private space by entering a member account and authentication code at said second network device.

3. The system of claim 2, further comprising a service center subsystem allowing said user to access image files stored on a third party network platform through said member account and authentication code.

4. The system of claim 1, further comprising a knowledge management server communicating with said second network device so as to selectively providing promotional activity information to said second network device, wherein said promotional activity information is associated with a location where said second network is at.

5. The system of claim 4, wherein said second network device sends consumer information collected back to said knowledge management server periodically or randomly to allow said knowledge management server to determine specific market information associated with said location.

6. The system of claim 1, wherein said second network device further comprises a payment mechanism to generate a payment code associated with one or more image files selected by said user, wherein when said payment mechanism confirms said payment code is linked to a paid status, said one or more selected image files is outputted.

7. The system of claim 2, further comprising a monitoring management subsystem for managing said member account and authentication code as well as said unique access code.

8. The system of claim 2, wherein said second network device further comprising a web camera so as to identify a biological feature of said owner of said private space for authentication purpose.

9. The system of claim 1, wherein said second network device further comprises an image file output slot so as to output one or more selected image files that have been paid for.

10. The system of claim 1, wherein said second network device further comprises a user interface to allow said user to input said unique access code.

11. The system of claim 6, further comprising a remote payment controller to communicate with said payment mechanism so as to confirm a payment status of said one or more selected image files.

12. A method for storing a plurality of image files on a cloud platform and outputting said plurality of image files from different locations, said method comprising:
defining a private space on said cloud platform through the Internet so as to upload said plurality of image files to said private space;
selectively assigning a unique access code to a set of image files or a single image file within said plurality of image files; and
accessing related image files utilizing said unique access code,
wherein said step of accessing related image files utilizing said unique access code comprises setting a respective privacy setting of said set of image files or said single image file within said plurality of image files, and when said privacy setting is set to open, said related image files can be accessed by entering said unique access code at a second network device, and when said privacy is set to private, said related image files cannot be accessed by entering said unique access code at said second network device, even when said unique access code entered is correct.

13. The method of claim 12, further comprising entering a member account and authentication code at said second network device so as to access any image files stored in said private space.

14. The method of claim 13, further comprising accessing image files stored on a third party platform through said member account and authentication code.

15. The method of claim 12, further comprising selectively providing relevant promotional activity information to said second network device based on where said second network device is at.

16. The method of claim 15, further comprising sending back consumer information to a knowledge management server so as to determine specific market information associated with said second network device.

17. The method of claim 12, further comprising generating a payment code associated with one or more selected image files, and outputting said one or more selected image files when said payment code is linked to a paid status.

18. The method of claim 17, further comprising receiving payment information so as to confirm said payment code is linked to said paid status.

19. The method of claim 13, further comprising managing said member account and authentication code as well as said unique access code.

20. The method of claim 12, further comprising identifying a biological feature of an owner of said private space for authentication purpose.
